(19) United States
(12) Patent Application Publication
(10) Pub. No.: US 2011/0258860 A1
(43) Pub. Date: Oct. 27, 2011

(54) OPTIMIZED MECHANICAL ADVANTAGE CUTTING TOOL

(75) Inventors: Thomas M. Chervenak, Stanley, NC (US); David P. Engvall, Stanley, NC (US); Mark B. Latronico, Charlotte, NC (US); Joseph Lutgen, Costa Mesa, CA (US)

(73) Assignee: IRWIN INDUSTRIAL TOOL COMPANY, Huntersville, NC (US)

(21) Appl. No.: 13/082,053

(22) Filed: Apr. 7, 2011

Related U.S. Application Data
(60) Provisional application No. 61/328,508, filed on Apr. 27, 2010.

(51) Int. Cl. B26B 17/00; B26B 13/28

(52) U.S. Cl. 30/266; 29/404

(57) ABSTRACT

A cutting tool and method comprises a first lever having a first jaw at one end. A second lever is connected to the first lever at a first pivot where the second lever has a second jaw that is opposed to the first jaw. A third lever is connected to the first lever at a second pivot and connected to the second lever at a third pivot such that relative movement of the third lever relative to the first lever between an open position and a closed position defines a stroke of the tool that corresponds to movement of the hand contact points on the levers toward one another. The third pivot comprises a pin engaging a cam surface where the cam surface has a shape such that the mechanical advantage may increase and decrease through the stroke of the tool and may be variable through the stroke of the jaws.

This application claims benefit of priority under 35 U.S.C. §119(e) to the filing date of to U.S. Provisional Application No. 61/328,508, as filed on Apr. 27, 2010, which is incorporated herein by reference in its entirety.

### BACKGROUND

Cutting tools such as cutting pliers typically comprise a pair of members that are pivotably connected to one another at a pivot pin. The members form opposed cutting jaws to one side of the pivot and opposed handles to the opposite side of the pivot. A cutting edge is formed on each of the cutting jaws that may be brought into engagement with one another to cut an article placed between the jaws when the handles are moved toward one another.

### SUMMARY OF THE INVENTION

A cutting tool comprises a first lever having a first jaw at one end. A second lever is connected to the first lever at a first pivot where the second lever has a second jaw that is opposed to the first jaw. A third lever is connected to the first lever at a second pivot and connected to the second lever at a third pivot such that movement of the first lever and third lever between an open position and a closed position defines a stroke of the tool that corresponds to movement of the jaws toward one another. The third pivot comprises a pin engaging a cam surface where the cam surface has a shape such that a mechanical advantage increases and decreases through the stroke of the tool.

The shape of the cam surface may be determined in part by an input force applied to the first and third levers. The input force may be related to the squeeze force of a user. The pin may exert a force on the cam surface where the direction of the force changes relative to the second lever during the stroke of the tool.

A cutting tool comprises a first lever having a first jaw at one end. A second lever is connected to the first lever at a first pivot where the second lever has a second jaw that is opposed to the first jaw. A third lever is connected to the first lever at a second pivot and to the second lever at a third pivot such that movement of the first lever and third lever between an open position and a closed position defines a stroke of the tool that corresponds to movement of the jaws toward one another. The third pivot comprises a pin on the third lever engaging a cam surface on the second lever where the cam surface has a non-linear shape such that the mechanical advantage between the levers and jaws is variable through the stroke of the jaws.

A method of designing a cutting tool comprises providing a first lever and a second lever pivotably connected to the first lever at a first pivot, the first pivot comprises a pin either on one of the first lever or the second lever that engages a cam surface on the other of the first lever or the second lever such that movement of the first lever causes the second lever to rotate; determining a shape of the cam surface using an applied input force.

The input force may be related to a user's hand strength. The step of determining a shape may comprise using a target cut force for an article to be cut as a function of jaw span. The shape may be determined to minimize the highest effort throughout the actuation of the tool. The effort may be based on a mechanical advantage of the tool as a function of hand span; a squeeze force function of a user's hand as a function of the hand span; and a cut force function of the target material as a function of jaw span. The method may comprise determining an optimized mechanical geometry of the shape of the cam surface.

### BRIEF DESCRIPTION OF THE DRAWINGS

FIG. 1 is a side view of a first embodiment of a cutting pliers of the invention in a closed position.

FIG. 2 is a side view of the embodiment of the cutting pliers of FIG. 1 in a partially open position.

FIG. 3 is a side view of the embodiment of the cutting pliers of FIG. 1 in a fully open position.

FIG. 4 is a perspective view of a second embodiment of a cutting pliers of the invention in a partially open position.

FIG. 5 is a side view of the embodiment of the cutting pliers of FIG. 4 in a partially open position depicting force vectors for hand force and cut force.

FIG. 6 is a side view of the embodiment of the cutting pliers of FIG. 4 in a partially open position.

FIG. 7 is a side view of a third embodiment of the cutting pliers in a closed position.

FIG. 8 is a side view of the third embodiment of a cutting pliers of FIG. 7 in a partially open position.

FIG. 9 is a side view of the embodiment of the cutting pliers of FIG. 7 in a fully open position.

FIG. 10 is a side view of a fourth embodiment of a cutting pliers of FIG. 7 in a closed position.

FIG. 11 is a side view of the embodiment of the cutting pliers of FIG. 10 in a partially open position.

FIG. 12 is a side view of the embodiment of the cutting pliers of FIG. 10 in a fully open position.

FIG. 13 is a side view of a fifth embodiment of a cutting pliers of the invention in a near fully open position.

FIG. 14 is a side view of the embodiment of the cutting pliers of FIG. 13 in a partially open position.

FIG. 15 is a side view of the embodiment of the cutting pliers of FIG. 13 in a closed position.

FIG. 16 is a side view of a sixth embodiment of a cutting pliers of the invention in a fully open position.

FIG. 17 is a side view of the embodiment of the cutting pliers of FIG. 16 in a partially open position.

FIG. 18 is a side view of the embodiment of the cutting pliers of FIG. 16 in a closed position.

FIG. 19 is a graph showing the relationship between jaw angle and mechanical advantage.

FIGS. 20 through 24 are partial side views of the pliers shown in FIG. 1 illustrating the force characteristics of the pliers as the pliers move between the open and closed positions.

FIG. 25 shows a series of graphs illustrating the operating parameters of the pliers shown in FIGS. 20 through 24.

FIGS. 26 through 28 are graphs used in explaining the method of making a pliers.

### DETAILED DESCRIPTION OF EMBODIMENTS OF THE INVENTION

The invention relates to cutting tools such as the cutting pliers shown in the drawings. While specific embodiments of cutting pliers are shown, the invention relates to a wide variety of cutting tools such as diagonal pliers, linesman pliers, long nose pliers, end cutters, snips and the like and has applicability to any tool where the force generation characteristics described herein may be useful. The terms “top”, “bottom”, “above” and “below” are used herein when describing the illustrated embodiments of the invention to facilitate the description of the tool, it is to be understood that in actual use the tools described herein may be used in any spatial orientation.

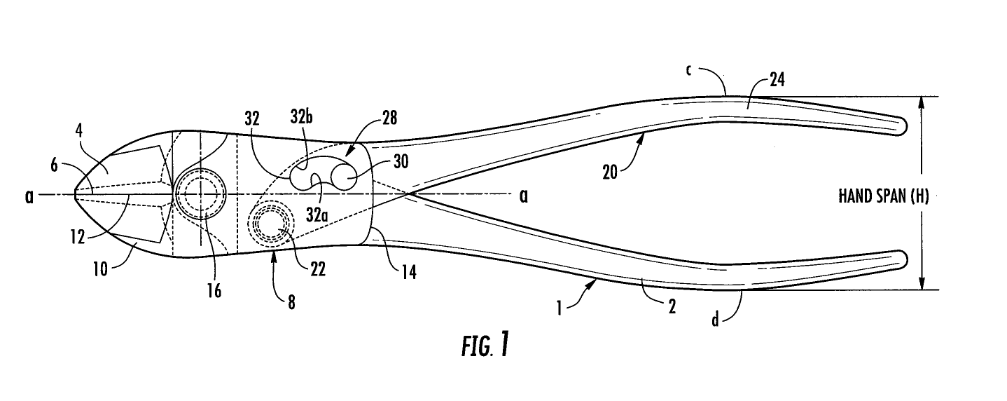

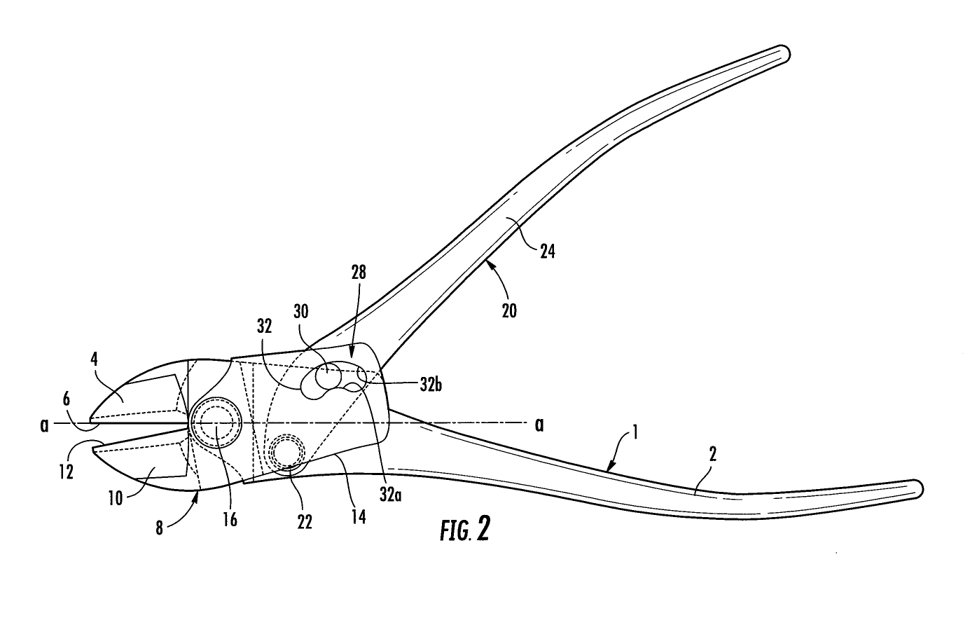

Referring to FIGS. 1 through 3 a first embodiment of a cutting tool is shown comprising a first lever assembly 1 comprising a first handle 2 that is fixed to a first jaw 4. In the illustrated embodiment the handle and jaw are made integrally and have a one-piece construction although the lever assembly may be made of separate components that are fixed to one another to create lever assembly 1. The first jaw 4 is formed with a cutting edge 6.

A second lever assembly 8 comprising a second jaw 10 having a cutting edge 12 is fixed to and pivoted relative to the first assembly 1 at pivot 16 such that the first jaw 4 can rotate toward and away from the second jaw 10 and an article located between the jaws 4 and 10 may be cut by cutting edges 6 and 12. The second lever assembly 8 comprises a stub 14 located on the opposite side of pivot 16 from jaw 10.

A third lever assembly 20 is fixed to and pivoted relative to the first lever assembly 1 at a second pivot 22. In the illustrated embodiment the pivot 16 is arranged generally along the cutting plane a-a of the pliers where the cutting plane a-a is the plane between the cutting edges 6 and 12 when the jaws are in the closed position perpendicular to the midplane of the tool. Pivot 22 is disposed in an offset position below plane a-a. The third lever assembly 20 comprises a handle 24 that extends generally opposite to the first handle 2 such that a user may grasp the pliers by the handles and press the handles toward one another to close the jaws 4 and 10 as will hereinafter be described. The handles may also be moved away from one another to open the jaws 4 and 10.

The third lever assembly 20 also engages the second lever assembly 8 at pivot 28 located above plane a-a. Pivot 28 comprises a pin 30 formed on the third lever assembly 20 that engages a slot 32 having a cam surface 32a formed on the stub 14 of the second lever assembly 8. While the cam surface 32a is shown as part of slot 32 formed in the stub 14, the cam surface 32a may be formed in other manners such as by creating a projection that extends from the one of the levers where the projection is formed with the cam surface 32a.

The three lever system shown in the drawings may be used to increase and optimize the mechanical advantage provided by the pliers. The mechanical advantage may be defined as the difference in output force applied by the jaws 4 and 10 to the article being cut as compared to the input force applied by the user's hand on the handles 2 and 24. Another measure of mechanical advantage is the difference in the relative amount of movement between the handles 2 and 24 compared to the amount of movement between the jaws 4 and 10.

As the handles 2 and 24 are closed (moved towards one another) by the user, the pin 30 rides on the cam surface 32a of slot 32 to rotate the second lever assembly 8 about pivot 16 such that the jaws 4 and 10 are closed. The cam surface 32a is arranged relative to the pivots 16 and 22 and is shaped such that the mechanical advantage curve provided by the pliers can be controlled to provide higher mechanical advantage where greater force at the cutting edges is needed during use of the tool and to provide lower mechanical advantage where less force is needed during use of the tool (e.g. cutting through the soft jacket of an insulated wire). In the embodiment of FIGS. 1 through 3 the surface 32a has an curved shape in a downward facing C-shape. The mechanical advantage curve may be modified by changing the shape of surface 32a to vary the mechanical advantage provided by the tool over the path of travel from the open position to the closed position based on the article to be cut and the user's hand strength. For a given hand span distance the movement of the tool from the open position to the closed position is referred to as the “stroke” of the tool.

To open the jaws 4 and 10 the handles 2 and 24 are pulled apart from one another such that pin 30 engages the opposite surface 32b of slot 32. The engagement of pin 30 with surface 32b rotates lever assembly 8 about pin 16 to move jaws 4 and 10 away from one another. Because increased or optimized mechanical advantage is not typically required during opening of the tool, surface 32b may have a wide variety of shapes and need not correspond to the shape of cam surface 32a.

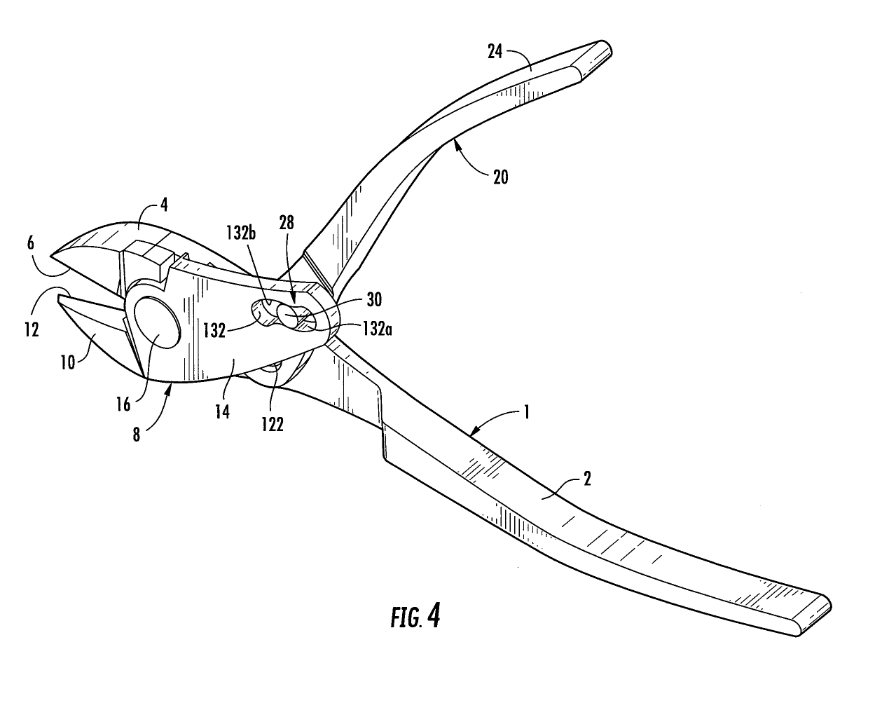

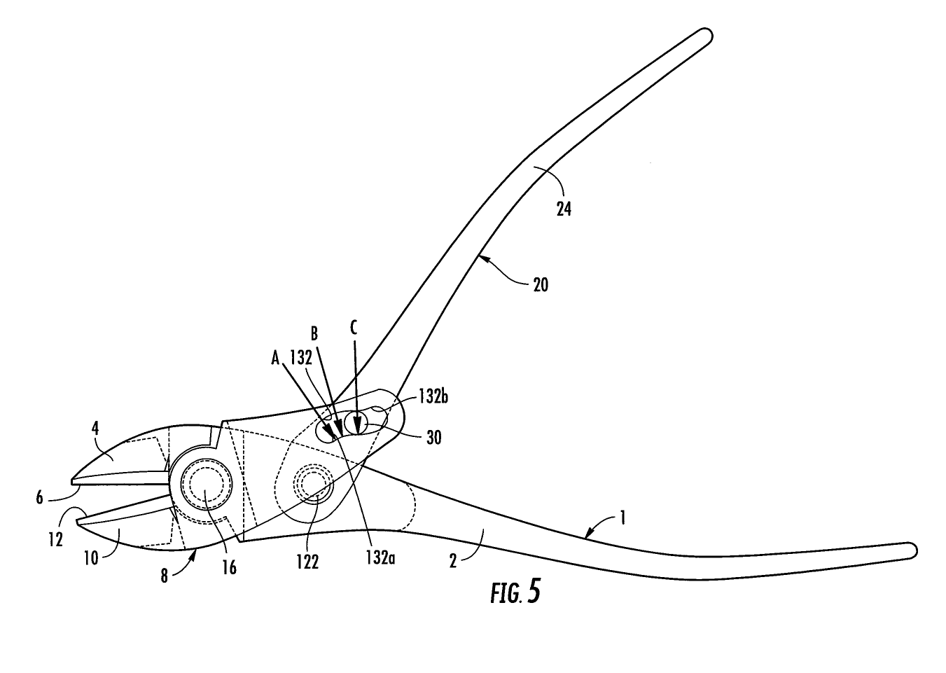

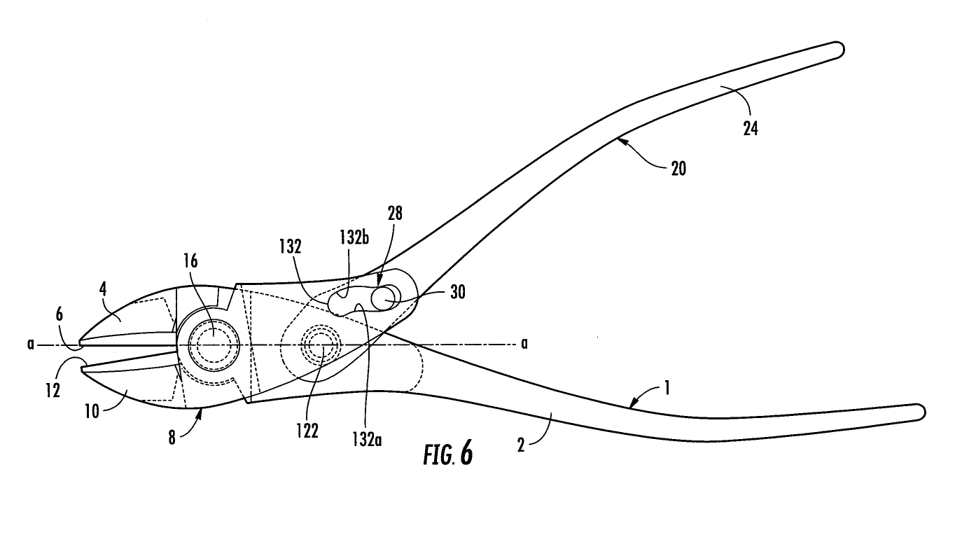

A second embodiment of cutting tool is shown in FIGS. 4 through 6 where like reference numerals are used to identify like components previously described with reference to FIGS. 1 through 3. The pliers of FIGS. 4 through 6 are similar to the pliers of FIGS. 1 through 3 except that pivot 122 is located on the plane a-a rather than below the plane a-a as shown in the embodiment of FIGS. 1 through 3. Further, the shape of slot 132 and cam surface 132a is different than the shape of slot 32 and cam surface 32a of the embodiment of FIGS. 1 through 3. In the embodiment of FIGS. 4 through 6 the cam surface 132a has an S-shape.

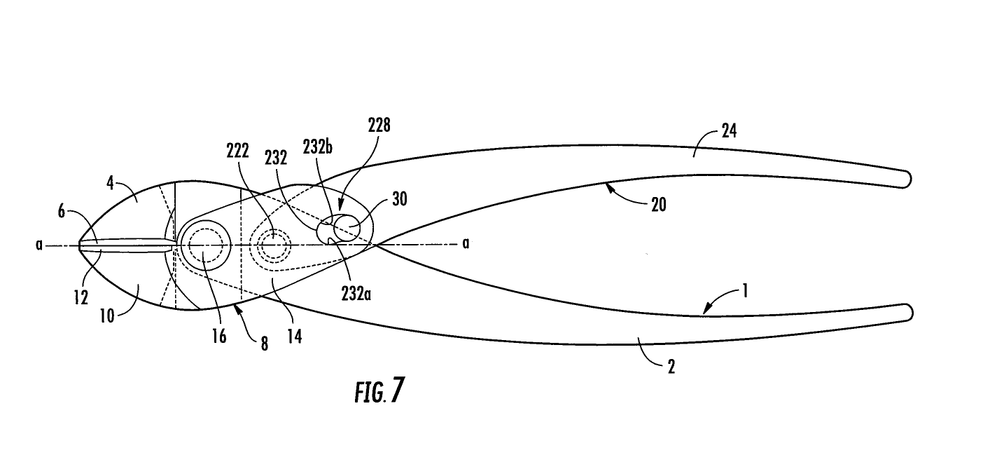

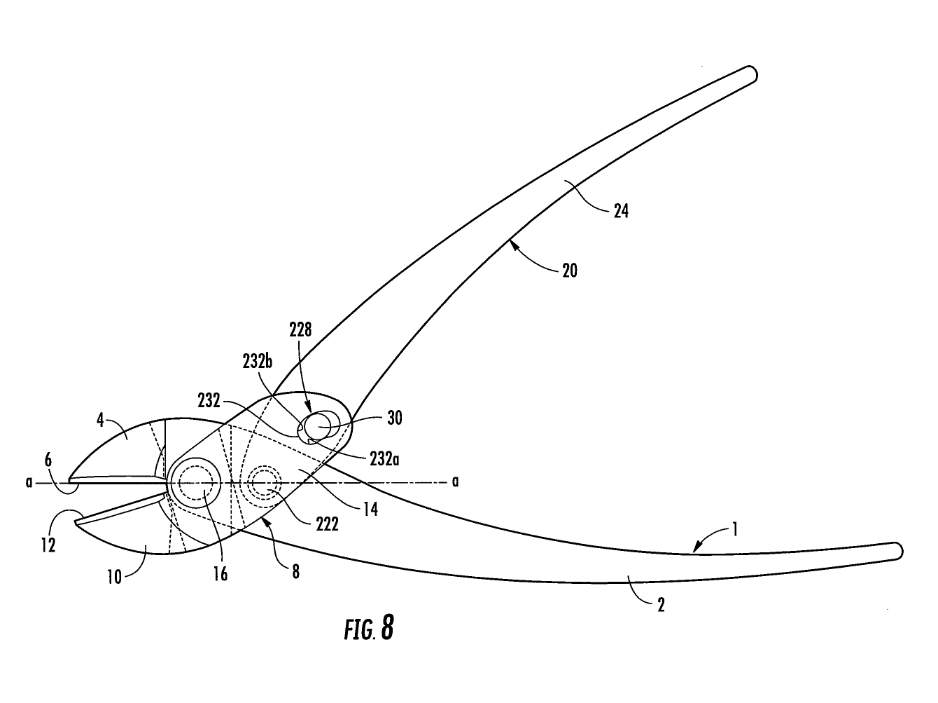

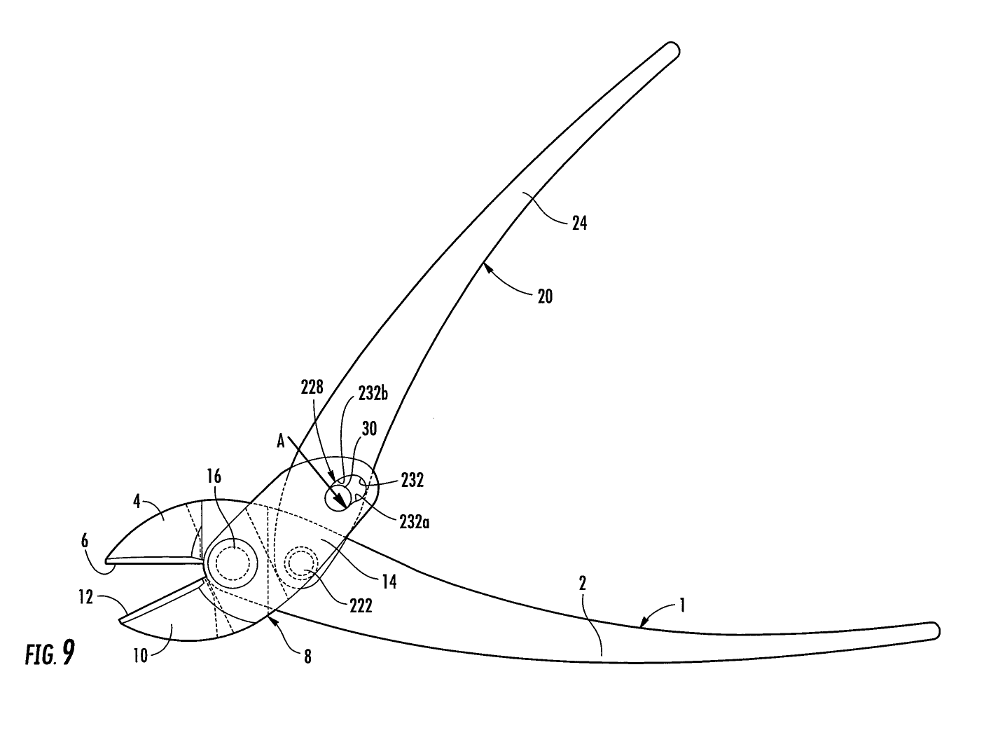

A third embodiment of a cutting tool is shown in FIGS. 7 through 9 where like reference numerals are used to identify like components previously described with reference to FIGS. 1 through 3. The pliers of FIGS. 7 through 9 are similar to the pliers of FIGS. 1 through 3 except that pivot 222 is located on plane a-a. In the embodiment of FIGS. 7 through 9 the cam surface 232a has a C-shape that is somewhat flattened and shortened compared to the C-shape of cam surface 32a of the embodiment shown in FIGS. 1 through 3.

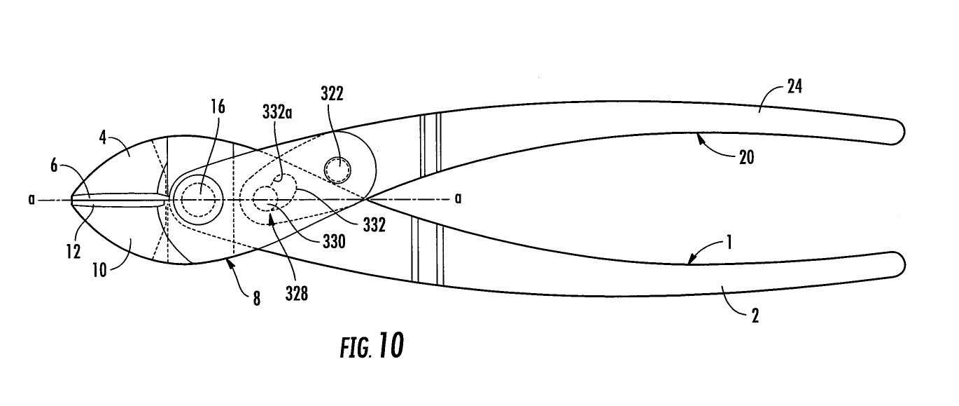

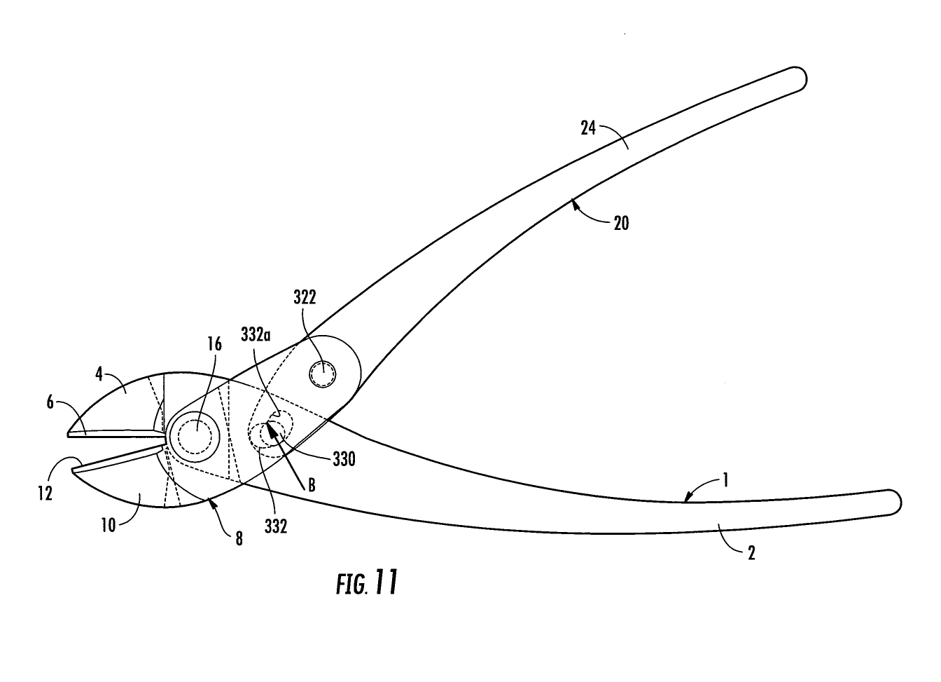

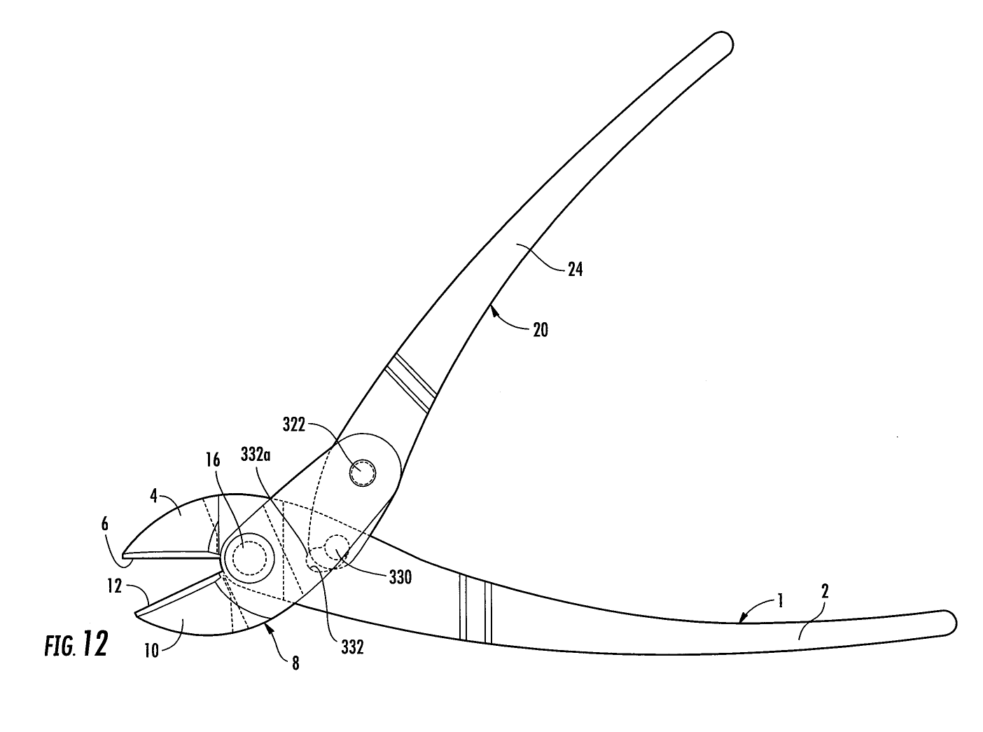

A fourth embodiment of a cutting tool is shown in FIGS. 10 through 12 where like reference numerals are used to identify like components previously described with reference to FIGS. 1 through 3. In the embodiment of FIGS. 10 through 12 lever assembly 20 is connected to second lever assembly 8 at a fixed pivot 322 and the end of the lever assembly 20 is connected to lever 1 at pivot 328. Pivot 16 and pivot 328 are disposed on plane a-a and pivot 322 is positioned above plane a-a. Pivot 328 comprises a pin 330 fixed to lever 20 that engages a slot 332 formed in lever 1. Slot 332 comprises a cam surface 332a against which the pin 330 bears when the pliers are closed. In the embodiment of FIGS. 10 through 12 the surface 332a has an upward facing C-shape where pin 330 contacts the top surface 332a of slot 332 during the closing movement of the pliers.

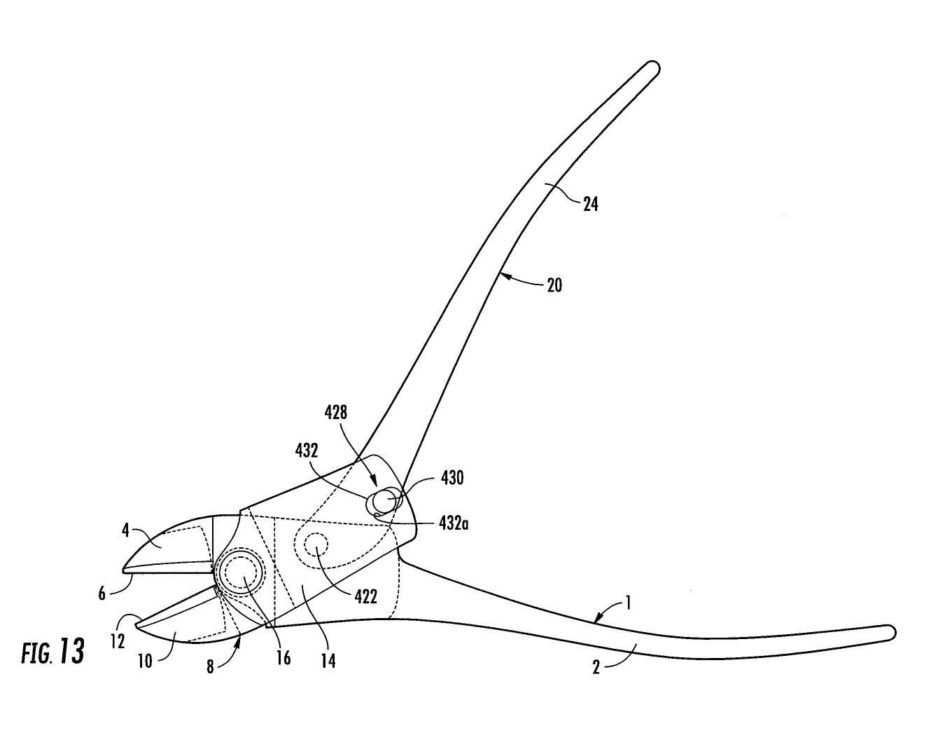

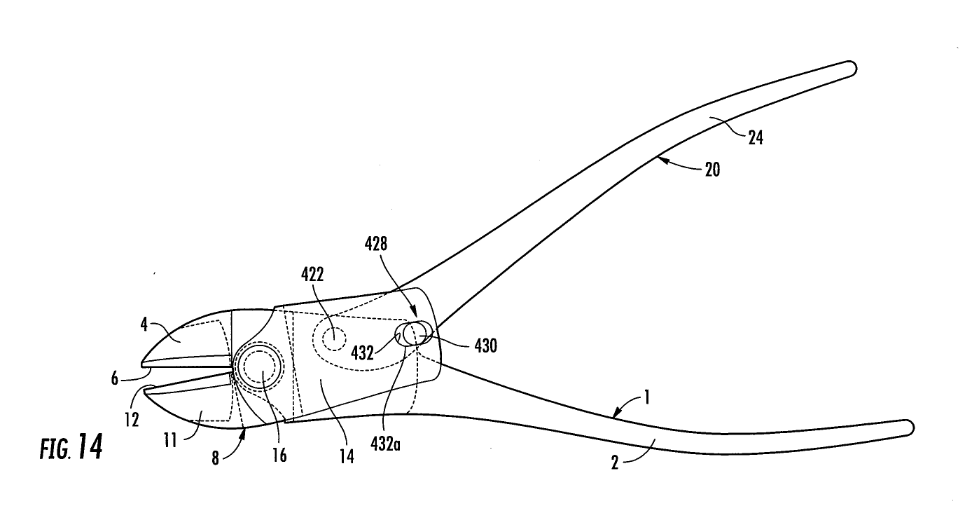

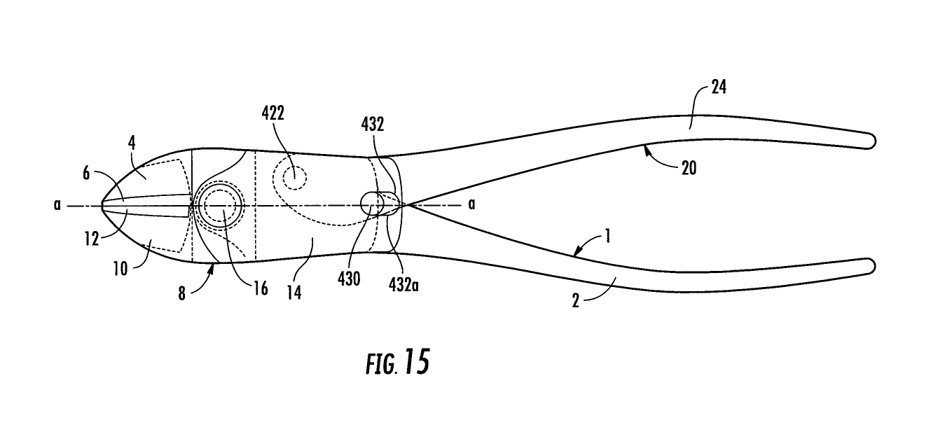

A fifth embodiment of a cutting tool is shown in FIGS. 13 through 15 where like reference numerals are used to identify like components previously described with reference to FIGS. 1 through 3. The pliers of FIGS. 13 through 15 are similar to the pliers of FIGS. 1 through 3 except that lever assembly 20 is connected to lever assembly 1 at pivot 422 where pivot 422 is positioned above plane a-a (see FIG. 15). Pivot 428 is located on plane a-a and comprises a pin 430 fixed to lever assembly 20 that engages a slot 432 formed in lever assembly 8. Slot 432 comprises a cam surface 432a against which the pin 430 bears during closing movement of the pliers. Surface 432a is relatively linear.

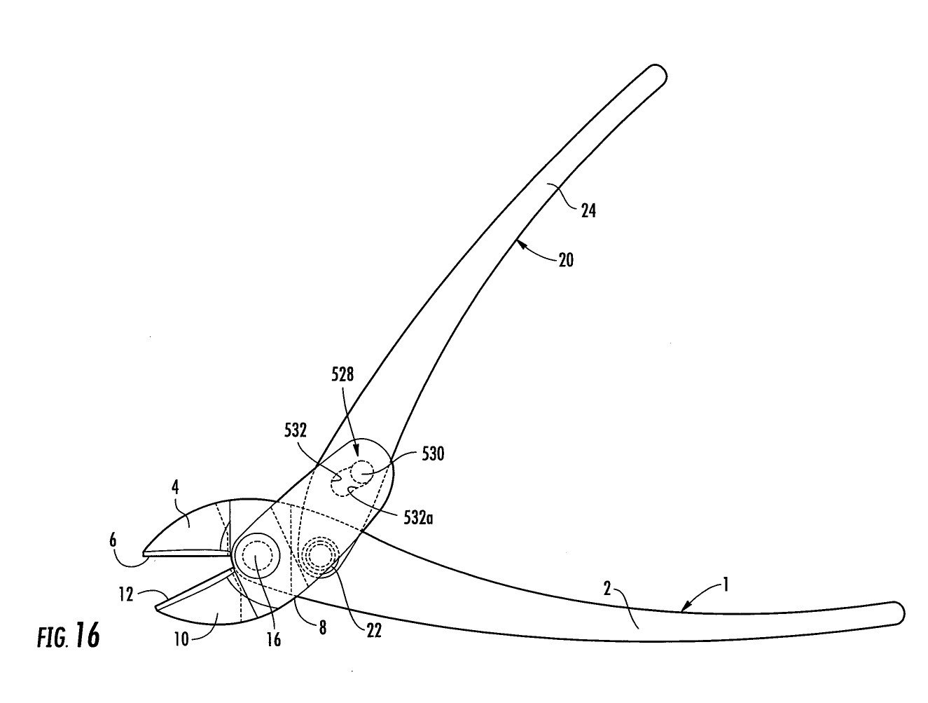

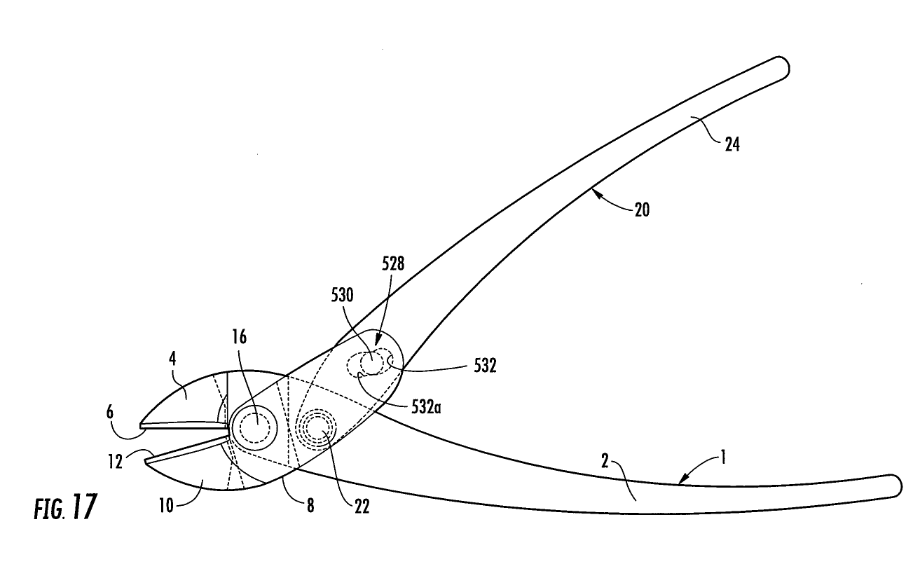

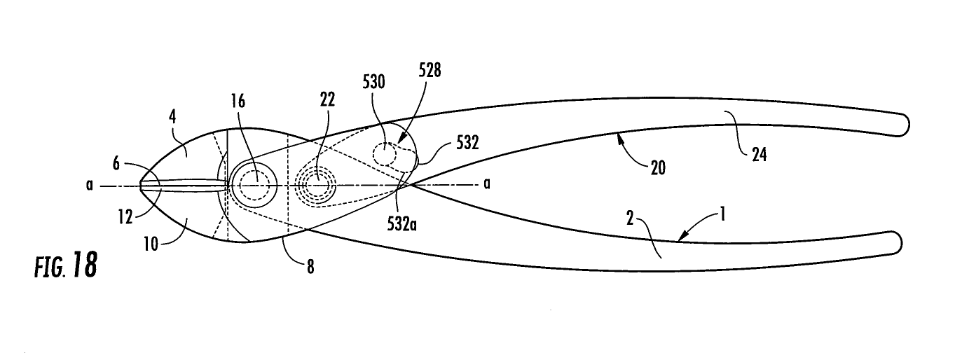

A sixth embodiment of the cutting tool is shown in FIGS. 16 through 18 where like reference numerals are used to identify like components previously described with reference to FIGS. 1 through 3. Pivot 528 is located above plane a-a (FIG. 18) and the pin 530 is fixed to lever assembly 8 and the slot 532 is located in lever assembly 20. Slot 532 comprises a cam surface 532a against which the pin 530 bears during closing movement of the pliers. Cam surface 532a has a flattened S-shape.

For most efficient cutting, it has been determined that greater force should be applied by the jaws on the work piece nearer the end of travel of the jaws, i.e. greater force should be applied by the jaws as the jaws close on the workpiece being cut. The mechanical advantage curve is used to take into account the user's hand strength. Because a typical user's hand strength generally increases as the pliers are closed, providing peak mechanical advantage at a point prior to the fully closed position (jaw angle of between approximately 12° and 17°) where hand strength is relatively lower compared to the required cutting force and then maintaining a relatively high mechanical advantage (although less than peak) between the peak and the fully closed position compensates for a typical user's hand strength curve while providing sufficient mechanical advantage through the fully closed position. By incorporating the hand strength curve of a typical user's hand in designing the mechanical advantage curve of the tool, the tool may be designed to minimize the maximum effort a user must exert when making a cut using the tool. A methodology for designing the mechanical advantage curve will be hereinafter explained.

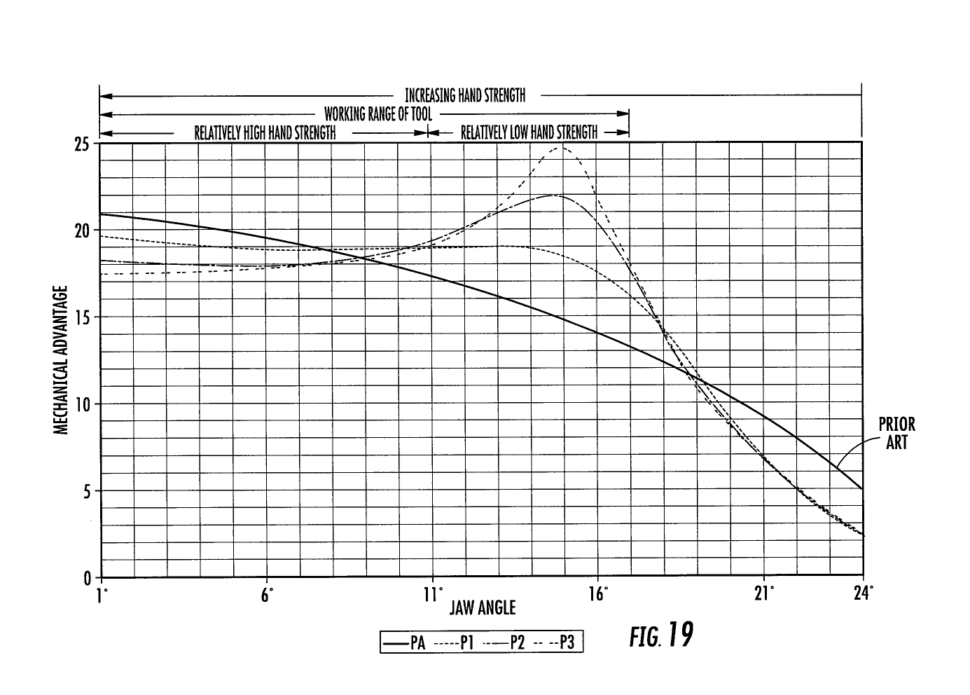

Thus, the mechanical advantage provided by the tool should typically be less during initial closing of the pliers (when little work is being done) and should reach a maximum as the pliers begin cutting the article and remain at a high level the through complete closing of the jaws. This is represented in the graph of FIG. 19. The graph of FIG. 19 shows the closing of the jaws, in degrees, along the X-axis as the jaws move from a fully open position (jaw angle 24°) to a fully closed position (jaw angle 1°). The graph shows mechanical advantage along the Y-axis. Three mechanical advantage curves P1, P2 and P3 of the invention are illustrated as well as one prior art curve PA. As is evident from this graph when the jaws are fully open (jaw angle 24°) the mechanical advantage is low (both in absolute value and as compared to a typical prior art pliers, PA) and as the jaws move toward the closed position the mechanical advantage increases reaching a maximum amount as the jaws close on the article to be cut. While in general the mechanical advantage is low when the jaws are fully open and higher as the jaws reach a closed position, the specific shape of the curve is controlled by the shape of the cam surface such that the application of the peak mechanical advantage can vary in amplitude and location and the amount of mechanical advantage provided by the pliers can be varied over the stroke of the tool as shown by lines P1, P2 and P3 for different configurations of the tool. For example, P1 has a peak mechanical advantage at the end of the stroke (1 degree) that is slightly greater than the second peak located at a jaw angle of approximately 13 degrees. Between the peak at 13 degrees and the peak at 1 degree the mechanical advantage gradually decreases slightly and then gradually increases. P2 has a peak mechanical advantage at about 14 to 15 degrees of jaw angle. The mechanical advantage gradually decreases from the peak until a slight increase at the very end of the stroke. The peak mechanical advantage of P2 is higher than the peak mechanical advantage of P1. P3 has a peak mechanical advantage at about 15 degrees that is higher than the peak mechanical advantage of P2. The mechanical advantage of P3 gradually decreases from the peak through the stroke of the tool. These mechanical advantage curves differ from the prior art curve PA that gradually increases over the entire stroke of the tool.

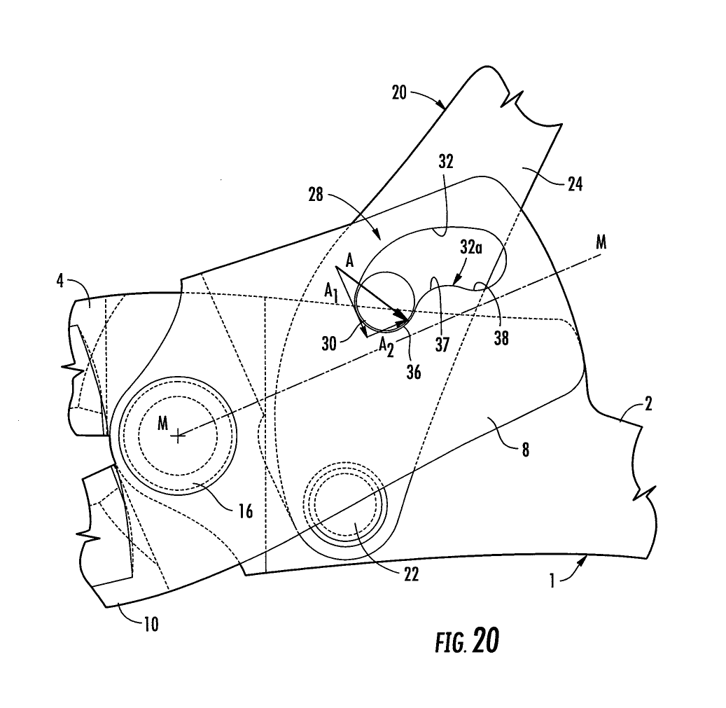

Before the methodology for designing the mechanical advantage curve is explained, the operation of the pliers for one mechanical advantage curve will be explained with respect to FIGS. 20-25 to illustrate the principles of operation of the pliers. Referring to FIG. 20, the pliers are shown in the fully open position. As the tool is closed, lever 20 rotates about pin 22 and is moved toward lever 1 by the user's hand. Typically, the user will grasp handles 2 and 24 in one hand and squeeze the handles positioning the thumb and palm on one handle and the fingers on the opposite handle. As lever 20 is moved toward lever 1, pin 30 is forced against and rides along cam surface 32a of slot 32 from the front of the slot toward the rear of the slot to force second lever assembly 8 to rotate about pin 16 (clockwise as viewed in FIG. 20) and move jaw 10 and jaw 4 towards one another.

Surface 32a has a first portion 36 that smoothly transitions into a second portion 38 through transition portion 37. The first portion 36 of surface 32a is formed at a first angle relative to pins 16 and 22 and the second portion 38 is formed at a second angle relative to the pins 16 and 22 with smooth transition portion 37 transitioning between the first portion 36 and second portion 38. The first portion 36 is sloped upwardly relative to axis a-a from the front of the pliers toward the rear of the pliers. The second portion 38 is sloped downwardly relative to axis a-a from the front of the pliers toward the rear of the pliers. The mechanical advantage provided by the tool varies as the angle of contact between pin 30 and surface 32a changes relative to the pivots 16 and 22 such that the mechanical advantage may be changed over the path of travel of the handles 2 and 24 by changing the shape of the cam surface 32a. At any point along surface 32a the force exerted by the pin 30 on the second lever assembly 8 is substantially normal to the surface 32a such that as the angle of surface 32a changes relative to the positions of pivots 16 and 22, the direction of the applied force relative to lever 8 and the mechanical advantage also changes.

Referring to FIG. 20, first portion 36 is oriented such that force exerted by the pin 30 on cam surface 32a is substantially along the line represented by arrow A (normal to surface 32a). The force has a first component A₁ that is directed perpendicular to the moment arm m-m of lever 8 and a second component A₂ that is directed along the moment arm m-m of lever 8. Because the force as represented by arrow A is at an angle relative to the moment arm of lever 8 only the first component A₁ of force A provides a torque on lever 8. In the early stages of movement of members 1 and 20 toward one another the shape of surface 32a is selected such that distance handles 1 and 20 move toward one another results in a similar distance of movement of jaws 4 and 10 toward one another (the lowest mechanical advantage).

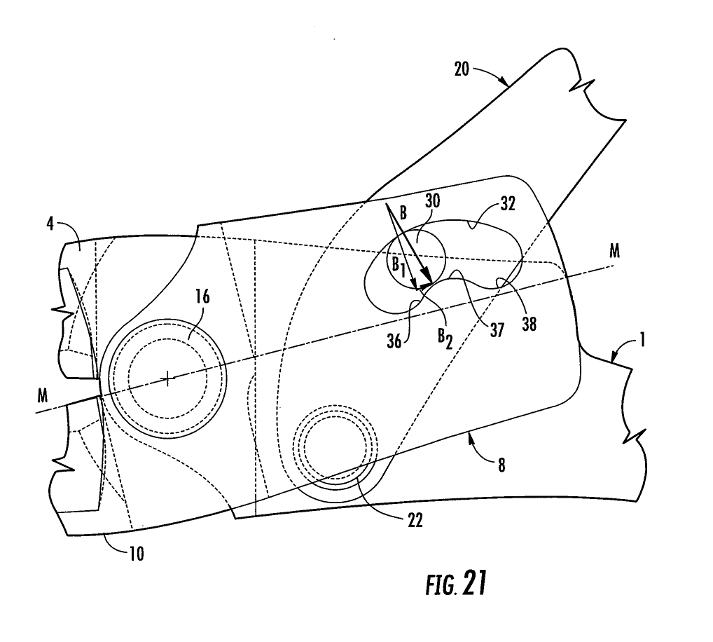

Referring to FIG. 21, as the handles move toward the closed position, pin 30 rides along portion 36 such that the angle of the force applied by pin 30 on lever 8 gradually moves to the orientation represented by arrow B. The force B has a larger first component B₁ that is directed perpendicular to the moment arm of lever 8 than in the position of FIG. 20 and a second component B₂ that is directed along the moment arm of lever 8. Because the force component B₁ that is perpendicular to the moment arm m-m on lever 8 is greater than the component A₁ (in the position shown in FIG. 20) force B provides a greater torque on lever 8 than force A. In this stage of movement of levers 1 and 20 toward one another the shape of surface 32a is selected such that the distance levers 1 and 20 move toward one another results in greater distance of movement of jaws 4 and 10 toward one another (an increasing mechanical advantage) over the position of FIG. 20.

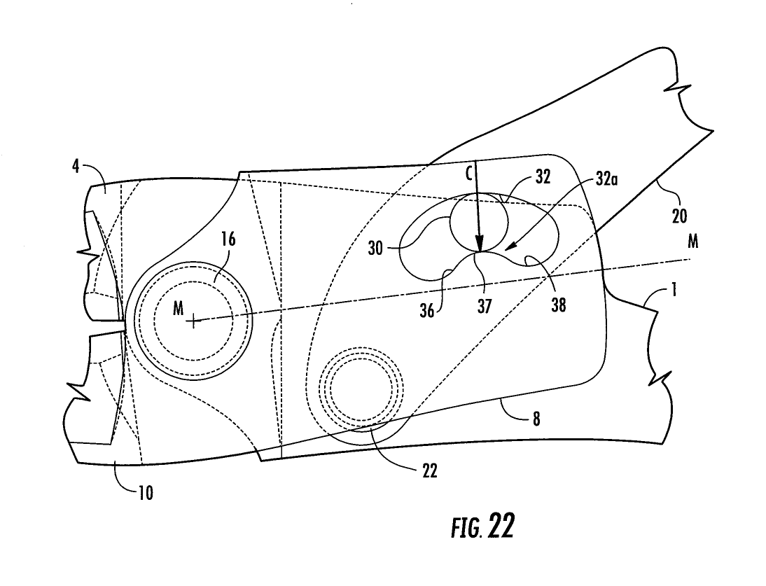

Referring to FIG. 22, as the handles continue to rotate to the closed position, the pin 30 crosses the transition portion 37 between the first portion 36 and the second portion 38 where the force exerted by pin 30 on surface 32a, as represented by arrow C, is perpendicular to the moment arm m-m of lever 8. In this position all or substantially all of force C is directed perpendicular to the moment arm of lever 8 and a small or zero component of the force is directed along the moment arm m-m of lever 8. Because the force component perpendicular to the moment arm of lever 8 is maximized force C provides a maximum torque on lever 8. In this stage of movement of members 1 and 20 toward one another the shape of surface 32a is designed such that distance handles 1 and 20 move toward one another results in the smallest distance of movement of jaws 4 and 10 toward one another (a maximum mechanical advantage when compared to the mechanical advantage applied in the orientation of FIGS. 20 and 21). In this area of the force curve a relatively large movement of levers 1 and 20 results in relatively small movement of jaws 4 and 10.

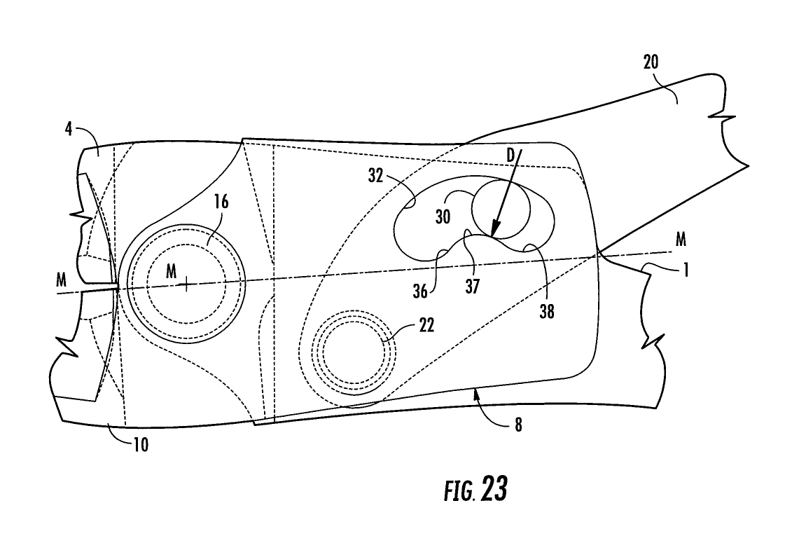

Referring to FIG. 23, as the pin 30 transitions to the second portion 38 the force exerted by the pin 30 is substantially along the line represented by arrow D where the force D is still directed largely perpendicular to the moment arm m-m of lever 8 and a relatively small movement of levers 1 and 20 results in relatively large movement of jaws 4 and 10. The force D has a relatively small force component that is directed parallel to the moment arm of lever 8 such that the mechanical advantage has decreased slightly from that of the position shown in FIG. 22. In this stage of movement of members 1 and 20 toward one another the shape of surface 32a is selected such that the distance levers 1 and 20 move toward one another results in a relatively great distance of movement of jaws 4 and 10 toward one another (a relatively high mechanical advantage although less than that of FIG. 22).

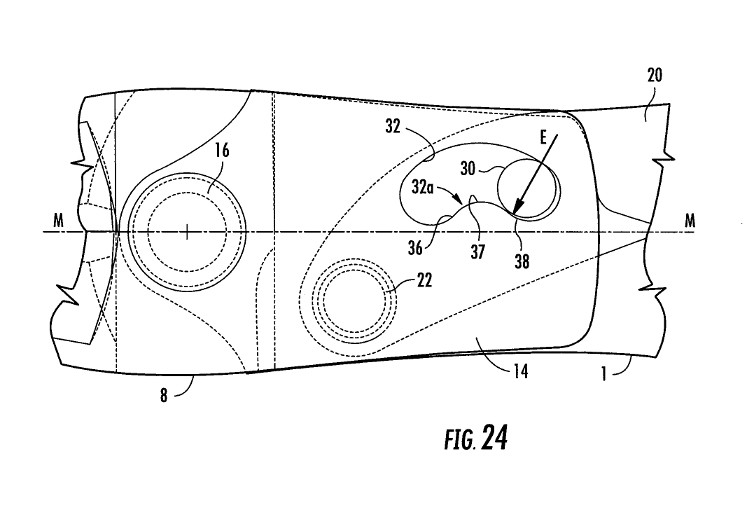

Referring to FIG. 24, as the pin 30 moves along the second portion 38 the force exerted by the pin 30 is substantially along the line represented by arrow E where the mechanical advantage is less than in the position of FIG. 23 but is still relatively high. The large mechanical advantage may be maintained through the full closing of the pliers such that a high mechanical advantage is provided as the cutting edges 6 and 12 cut through the article being cut. In the orientations shown in FIGS. 21, 22, 23 and 24 a large mechanical advantage is provided by the tool.

The effective moment arm of the cam follower force is also changing over the throw of the tool as the point at which the force is applied to lever 8 moves further from pivot 16. The perpendicular component of the cam follower force is also changing over the throw as described above. The product of the perpendicular distance and the perpendicular component produce the multiplier of the moment exerted on the handle to the resulting moment exerted on the jaw.

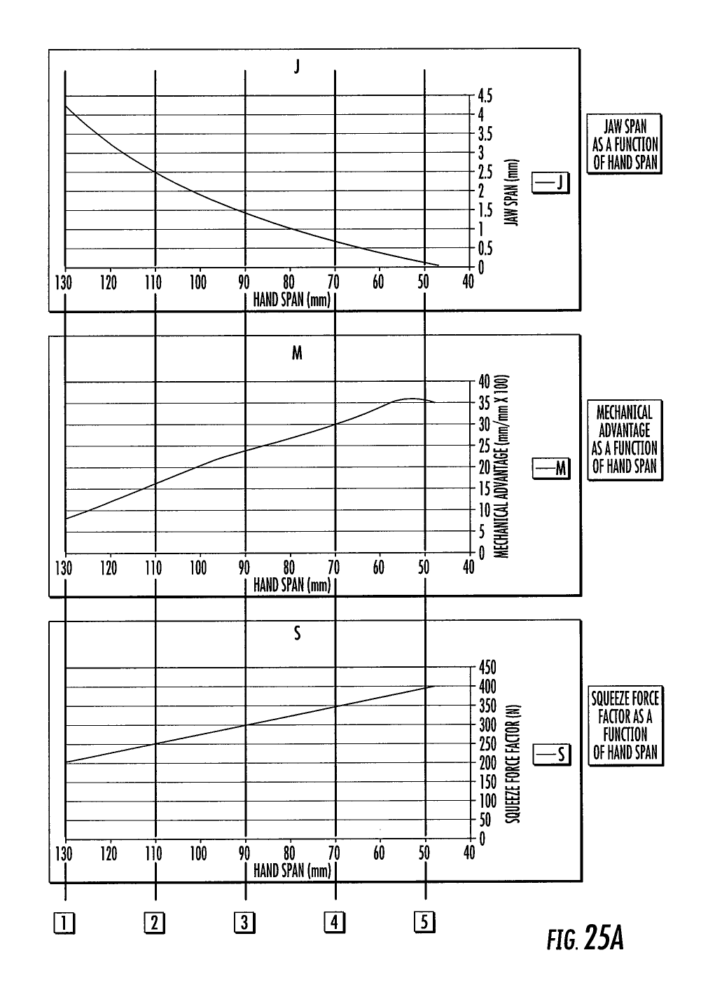

The graphs shown in FIG. 25 show the force curves of the pliers in the positions of FIGS. 20 through 24 with the positions of FIGS. 20 through 24 identified as positions 1 through 5, respectively, on the force curve graphs of FIG. 25. These graphs show where each of positions 1 through 5 fall on the graphs of: Jaw Span as a function of Hand Span, Mechanical Advantage as a function of Hand Span, Squeeze Force Function as a function of Hand Span, Cut Force Function as a function of Hand Span and Effort as a function of Hand Span. Other embodiments of the tool such as those shown in FIGS. 4 through 18 may be designed to have similar, although not necessarily identical, performance characteristics.

The shape of the cam surface 32a can be modified to change the force curve of the pliers such that the location of the higher mechanical advantage can be moved and the peak mechanical advantage applied by the pliers may be changed in both location and amplitude, examples of which are shown in FIG. 19. While the shape of the cam surface 32a may be varied to optimize the force curve of the tool, in operation of the tool other functions may affect the shape of the force curve. For example, as the tool moves from open position 1, FIG. 20, to the closed position 5, FIG. 24, the moment arm of lever 8 lengthens as the point of contact between pin 30 and surface 32a moves away from pivot 16. Further, the positions of pivot 22 and pivot 28 relative to one another and to pivot 16 may also change the force curve of the tool.

The method of making a cutting tool as described herein comprises pivotably connecting a first lever to a second lever at a first pivot where the first pivot comprises a pin on one of the first lever or the second lever that engages a cam surface on the other of the first lever or the second lever such that movement of the first lever causes the second lever to rotate. A shape of the cam surface is determined using an applied input force as one variable where the input force is related to a user's hand strength. The step of determining a shape of the cam surface may also comprise using a target cut force for an article to be cut as a function of jaw span. The shape of the cam surface is determined to minimize the highest effort throughout the actuation of the tool. The effort is based on a mechanical advantage of the tool as a function of hand span; a squeeze force function of a user's hand as a function of the hand span; and a cut force function of the target material as a function of jaw span. The method further comprises determining an optimized mechanical geometry of the shape.

One design approach to design the pliers to customize the force curve to a particular article being cut is described below. The steps as described herein may be used to arrive at an optimized geometry for the Optimized Mechanical Advantage Profile (OMAP) pliers as shown herein or of other pliers, cutting tools or similar tools. The method described herein may be used with any of the disclosed embodiments and may be used to design tools having cam surfaces with configurations other than those shown in the attached drawings. The spreadsheet analysis and optimization for the C-Slot embodiment of FIGS. 20 through 24 is shown in Appendix A. The methodology of the optimization process for determining the design shown in FIGS. 20 through 24 and in Appendix A will be described below. A similar optimization process may be used with all of the other illustrated embodiments and with any other tool designed as described herein.

The optimization process starts with analyzing a first try at the geometry of the tool and then modifying the geometry to minimize the peak hand “effort” required to cut a given work piece. The calculation for optimizing the geometry takes into account the cut force required at the jaws for a selected material to be cut as a function of jaw span and the hand strength available to be applied to the handles for a characteristic hand strength as a function of hand span. The geometry of the cam surface may be customized to vary the mechanical advantage of the tool of the range of motion of the tool. The optimization process adjusts the variable mechanical advantage of the tool to put lower mechanical advantage in the range of the stroke where mechanical advantage is needed the least and so that a higher mechanical advantage is available in the range of the stroke where it is needed the most.

One method for designing the OMAP pliers is described as follows:

Variable Definitions:

| | |
|---|---|
| H | Distance between points fixed to each handle |
| J | Distance between points fixed to each jaw |
| J = p(H) | Jaw Span as a function of Hand Span |
| G = p′ = dJ/dH | Rate of change of the Jaw Span as a function of |
| | Hand Span |
| M = 1/G | Mechanical Advantage as a function of Hand |
| | Span is the reciprocal of the function G, above |
| S = q(H) | Squeeze Force Function as a function of Hand |
| | Span (from empirical tests) |
| C = r(J) | Cut Force Function as a function of Jaw Span |
| | (from empirical tests) |
| e = 1/M * C/S = G * C/S | Effort as a function of Hand Span (ratio of the |
| | hand force over the range of motion to the |
| | target users maximum hand force at that Hand |
| | Span |
| E % = e * 100 | Effort expressed as a percentage of the |
| | maximum hand force. |

The values of the first set of variables; H, J, G, M, S, C, e and E% result from analyzing the first try at the mechanism design and the empirical data gathered for the cut force required for the target material, and the hand force available for the characteristic user's hand. The motion data for the analysis is generated with a computer mechanism model that simulates the motion of the tool over the range of motion. The calculations for the analysis are accomplished with a computer spreadsheet capable of fitting polynomial equations to X,Y data sets. In the spreadsheet the curve fitting process is called curve regression or trend line generation.

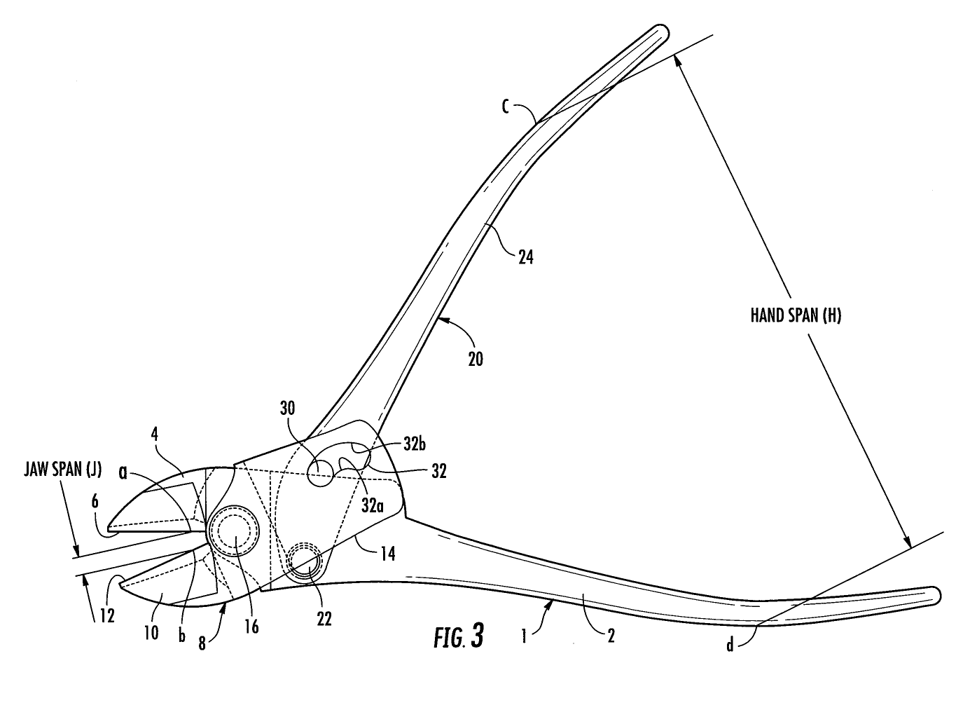

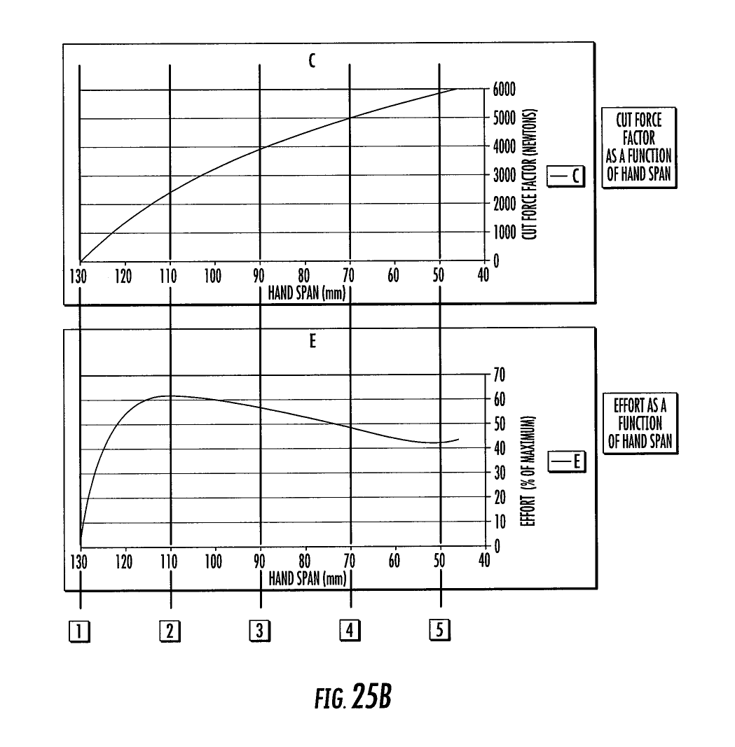

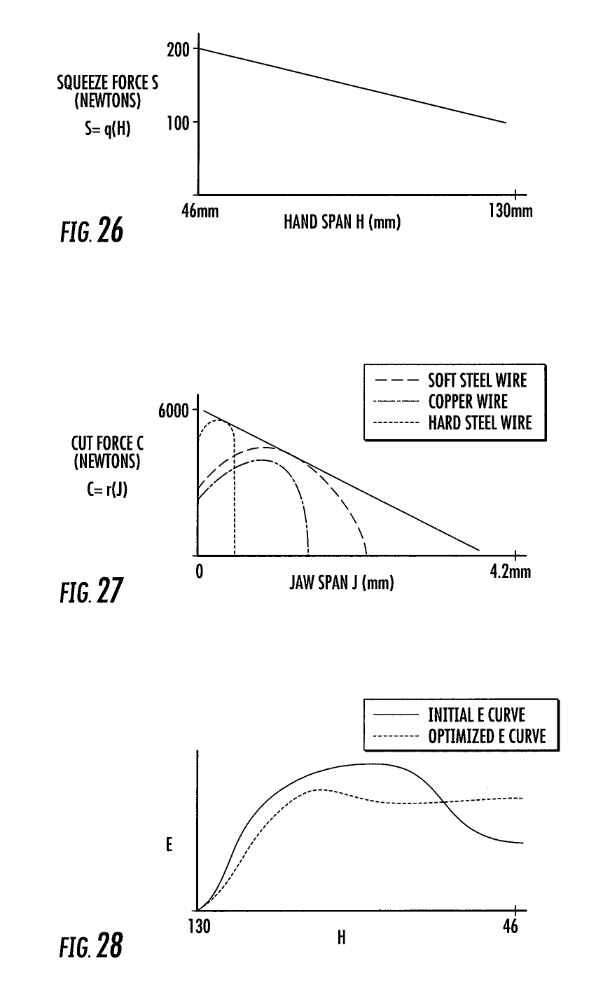

Observing the results of the analysis reveals where the “effort” curve needs to be adjusted to reduce the peak “effort”. “Effort” is defined, in the context of this invention, as the hand force required as it varies over the range of motion, divided by the maximum hand force available from the characteristic user hand for the corresponding hand span. In other words, E% is the percentage of the maximum hand force that is actually needed to move the handles at any given hand span.
1. Construct a model such as a computer mechanism model of a proposed tool component assembly.
2. Run a computer mechanism motion simulation to generate the stepwise relationship between hand span and the jaw span for the operational range of motion. For each of the hand span data points, the corresponding jaw span data point is determined. Typically, the data points are selected to cover the entire range of motion between the fully open position and the fully closed position. Referring to FIG. 3 each jaw span data point (J) is the distance between two physical points a, b, one point fixed on each jaw, selected such that the distance between points a, b is zero when the jaws are closed. The points a, b are located a known distance from pivot 16. The location of the jaw span points a, b approximate the location of jaw contact with the material being cut. The hand span data point (H) is the distance between two points c, d one point fixed to each handle such that the hand span (H) is at a minimum when the jaw span (J) is zero. The hand span approximates the distance between the points of contact of the user's hand operating the tool. The minimum jaw span J is zero when the jaws are closed and is a maximum when the jaws are fully open and corresponds with the maximum and minimum hand span positions.
3. Compute an N order polynomial curve regression on the data set from step 2 resulting in the function J=p(H). This is a fifth order polynomial of the jaw span (J) as a function of the hand span (H) and allows the equation J=p(H) to be used instead of a set of X, Y data points. For example, 100 hand span (H) and jaw span (J) data points may be used.
4. Generate the first derivative G=dJ/dH of the function J=p(H). The function G gives the slope of the J=p(H) function, in other words the rate of change of J as a function of H.
5. The mechanical advantage (M) of the tool at any point in the range of motion is the reciprocal of G (M=1/G). For example, if the rate of change of the jaw span is 1/12 of the rate of change of the hand span at a given position of articulation of the mechanism, the mechanical advantage at that position is 12:1. One unit of force on the handles directed between the handle points c, d would result in twelve units of force directed between the jaw points a, b (neglecting friction). The method of the invention allows the geometry of the tool to be designed such that the mechanical advantage of the tool, at any position of articulation, can be optimized to provide greater mechanical advantage where the required jaw force is higher and/or the user hand strength is lower and to lower the mechanical advantage in the range of motion where the required jaw force is low and/or the hand strength is higher.
6. From experiments it has been determined that the human hand has a characteristic relationship of maximum squeeze force (S) as a function of hand span. For example, data shows that at a wide hand span of 130 mm the typical hand is capable of exerting 200 Newtons and the same hand at a hand span of 46 mm is capable of exerting 400 Newtons. Because hand strength can vary between individuals the method of the invention can use an average or typical user's maximum squeeze force as a function of hand span. This relationship may be approximately quantified as a linear relationship. As shown in FIG. 26, an n order polynomial or other function could also be used to refine the “Squeeze Force Function” further for a specific person or group of people with similar hand strengths.
7. The cutting force function C is defined as the force necessary to move the cutting edges through the material being cut as a function of jaw span. Cut force varies greatly between different materials being cut, cutting edge geometries and jaw spans. From experiments it has been determined that the cut force for specific materials can be measured as a function of jaw span during the cutting stroke. Cut force measurements from experiments on various different materials can be superimposed to result in a target cut force as a function of jaw span. As shown in FIG. 27, the linear relationship in the illustrated example is an approximation of the highest force from various materials and edge geometries as a function of jaw span. An n order polynomial or other function could also be used to refine the “Cut Force Function” further for a specific material and/or specific edge geometries. In other words, if this method were to be used to design a tool to cut a single specific material, the C=r(J) function would match the cut force function of that specific material.
8. The “Effort” Calculation addresses the following three contributing relationships to optimize the “quality” of the users experience when actuating the tool. The contributing relationships are:
M=p(H) Mechanical Advantage of the tool as a function of hand span (H).
S=q(H) Squeeze Force Function of the target users hand as a function of the hand span (H).
C=r(J) Cut Force Function of the target material as a function of jaw span (J).
The equation for “Effort” is e=C/(S×M). Substituting G=1/M gives e=(G×C)/S. This equation expresses the ratio of the user's actual hand force divided by the maximum hand force over the range of motion of the actuation. For example, C=2000 Newtons, S=150 Newton, M=30 (30:1). For a given position of the tool e=1/((30×2000)/150)=0.44. Converting e to a percentage E%=e×100 or E%=44% of maximum hand force. This equation is not easy to solve because the cut force C is a function of jaw span J and the squeeze force S is a function of the hand span H resulting in two independent variables. The two independent variables are only related to each other through the variable mechanical advantage action of the mechanism described by the function G.
9. E% represents, over the range of motion, the percentage hand force required to make the cut compared to the maximum hand force available. The optimization of the mechanism seeks to keep the maximum E% value as low as possible over the range of motion. E% plots effort in a range of 0 to 100%.
9. The design method seeks to minimize the highest effort point throughout the actuation of the tool. Once the effort curve E is known for the initial configuration of the mechanism, adjustments can be made to lower the peak effort and increase the effort in the low areas as shown in FIG. 28. The calculation allows the Optimized Ecurve to be used to adjust the jaw span as a function of hand span J=p(H). This is done by solving the Effort equation for G, e=G*C/S. Solving for G, G=e*S/C. This equation does not easily provide a solution because the right side of the equation has two independent variables J and H because S=q(H) and C=r(J). But a piecewise solution can be generated knowing the following: For example, Initial Condition for J=p(H), J=0 where H=46 and the slope G at H=46 can be calculated from G=e*S/C. The estimated slope at the next point can be calculated at H+(increment of H), using the “Improved Euler Method” the average of the slope at the initial H and the slope at H+(increment of H) gives a usefully accurate value of J and H at the next point. This calculation is repeated for each increment of H through the range of motion. This calculation results in an optimized J=p(H) function which allows the mechanical geometry of the mechanism to be modified to give the optimized J=p(H) function.
10. dH is the interval for each step of the piece-wise integration. dH is calculated by subtracting a value of the hand span from the previous value of the hand span from the computer mechanism model. This interval changes over the range of motion because the only constant in the computer mechanism motion solver is the rotational velocity of the jaw.
11. j is the recovered jaw span as a function of the hand span calculated with the Improved Euler Method from the e, S and C curves. Essentially this is a check that the original calculation of the e curve is correct. The j values don't exactly match the original J values because the Improved Euler Method introduces small errors at each step.
12. k1 and k2 are the variables used within the Improved Euler Method for the piece-wise integration. k1 is the slope of the recovered j curve at the first point H. k2 is the estimated slope of the recovered j curve at the next point H.
13. “e ideal” is an estimate of the ideal effort curve manually entered to reduce the e effort value where it is too high and increase the effort values in some areas that can be brought up to result in approximately the same area under the original e effort curve but with a lower peak value. In the spreadsheet calculation this is done by entering ten points that create an effort curve with generally the right shape, for example increasing rapidly from 130 mm to 100 mm hand span and then nearly leveling off but slightly increasing for the remainder of the range of hand span motion from 100 mm to 46 mm. This curve shape seeks to give the tool user the experience of nearly the same but slightly increasing hand effort over the range of motion where the tool is actually cutting the working material. Again, the important consideration here is to reduce the peak effort to the lowest practical value. Then, when this first estimate of the ideal effort curve is used to calculate back to the “j ideal” value the fully open jaw span falls a little too small or a little too wide. The “e ideal” curve is then offset up or down with the “Vertical Shape Shift” to make the fully open jaw span match the desired original value.
14. “j ideal” is the new optimized jaw span as a function of hand span based on the e ideal curve. This list of one hundred numbers gives the optimized jaw span for each of the original hand span values H. The “j ideal” values are then used to modify and optimize the cam shape of the mechanism as follows. Locate the handle span at one of the original H values in the computer mechanism modeler. Locate the jaw span at the corresponding “j ideal” value. This locates one of the cam contact points. Repeat this procedure for several more hand span points over the range of motion each generating a cam contact point. Then connect the cam contact points together with a spline curve in the computer model and the optimized OMAP cam surface geometry is the result.
15. k1 ideal and k2 ideal, as before, are the variables used internally by the Improved Euler Method to perform the piece-wise integration of the “e ideal” curve incorporating the C function and the S function to produce the “j ideal” data set.
16. g is the first derivative, the slope, of the “j ideal” curve. m is the reciprocal of g showing the mechanical advantage of the mechanism at each position of hand span resulting from the optimized cam geometry.

The embodiments of the cutting tool shown and described herein provide a cutting tool that incorporates the hand span of the user and the corresponding squeeze force with an optimized mechanical advantage curve to provide: low mechanical advantage in the initial non-working segment of the cutting stroke; to increase the mechanical advantage where a user's squeeze force is low (and the tool is working on an article to be cut); and to decrease the mechanical advantage as the user's squeeze force increases through the working movement of the tool. The effect of this optimization design is that the user doesn't experience a “peak” effort during the cutting stroke as the user's effort curve is leveled out through the working stroke of the tool.

While specific embodiments of the cutting tool and specific examples of optimized curve calculations are shown, the shape of the cam surface and the position of the cam surface relative to the lever pivots may vary from the illustrated examples to accommodate the specific material being cut, the hand strength of the targeted user group, the geometry of the cutting edges and the like. Further, the method of the invention may be used to design a force curve having characteristics other than as specifically described herein. For example, the size or geometry of the article being cut may require that the force curve be shifted to provide peak mechanical advantage earlier or later in the cut stroke or to provide a greater or lesser peak mechanical advantage than as shown and described herein. Further, the force curve may be shifted to provide a different feel to the user where the user's “effort” may be varied through the cutting stroke.

While embodiments of the invention are disclosed herein, various changes and modifications can be made without departing from the spirit and scope of the invention as set forth in the claims. One of ordinary skill in the art will recognize that the invention has other applications in other environments. Many embodiments are possible. The following claims are in no way intended to limit the scope of the invention to the specific embodiments described above.

1. A cutting tool comprising:
a first lever having a first jaw at one end;
a second lever connected to the first lever at a first pivot, the second lever having a second jaw that is opposed to the first jaw;
a third lever connected to the first lever at a second pivot and connected to the second lever at a third pivot such that movement of the first lever and third lever between an open position and a closed position defines a stroke of the tool that corresponds to movement of the jaws toward one another;
the third pivot comprising a pin engaging a cam surface, the cam surface having a shape such that a mechanical advantage increases and decreases through the stroke of the tool.

2. The cutting tool of claim 1 wherein the shape is determined in part by an input force applied to the first and third levers.

3. The cutting tool of claim 2 wherein the input force is related to the squeeze force of a user.

4. The cutting tool of claim 1 wherein the cam surface has a curved shape.

5. The cutting tool of claim 1, wherein the pin exerts a force on the cam surface, the direction of the force changing relative to the second lever during the stroke of the tool.

6. The cutting tool of claim 1 wherein the cam surface has a first surface disposed an angle relative to a second surface.

7. The cutting tool of claim 1 wherein the cam surface has a C-shape.

8. The cutting tool of claim 1 wherein the cam surface has an S-shape.

9. The cutting tool of claim 1 wherein the cam surface has a first surface disposed at a first angle relative to the first pivot and a second surface disposed at a second angle relative to the first pivot.

10. The cutting tool of claim 1 wherein the pin exerts a force on the cam surface in a direction, the direction of the force changes in a direction relative to the moment arm of the second lever.

11. The cutting tool of claim 1 wherein the pin exerts a force on the cam surface in a direction, the direction of the force changes in a direction relative to the first pivot.

12. The cutting tool of claim 1 wherein the pin exerts a force on the cam surface in a direction, the direction of the force changes in a direction relative to the second pivot.

13. The cutting tool of claim 1 wherein the pin exerts a force on the cam surface in a direction, the direction of the force changes in a direction relative to the third pivot.

14. A cutting tool comprising:
a first lever having a first jaw at one end;
a second lever connected to the first lever at a first pivot, the second lever having a second jaw that is opposed to the first jaw;
a third lever connected to the first lever at a second pivot and connected to the second lever at a third pivot such that movement of the first lever and third lever between an open position and a closed position defines a stroke of the tool that corresponds to movement of the jaws toward one another;
the third pivot comprising a pin on the third lever engaging a cam surface on the second lever, the cam surface having a non-linear shape such that the mechanical advantage between the levers and jaws is variable through the stroke of the jaws.

15. A method of designing a cutting tool comprising:
providing a first lever and a second lever pivotably connected to the first lever at a first pivot, the first pivot comprising a pin on one of the first lever or the second lever that engages a cam surface on the other of the first lever or the second lever such that movement of the first lever causes the second lever to rotate;
determining a shape of the cam surface using an applied input force.

16. The method of claim 15 wherein the input force is related to a user's hand strength.

17. The method of claim 15 wherein the step of determining a shape comprises using a target cut force for an article to be cut as a function of jaw span.

18. The method of claim 15 wherein the shape is determined to minimize the highest effort throughout the actuation of the tool.

19. The method of claim 18 wherein the effort is based on a mechanical advantage of the tool as a function of hand span; a squeeze force function of a user's hand as a function of the hand span; and a cut force function of the target material as a function of jaw span.

20. The method of claim 15 further comprising determining an optimized mechanical geometry of the shape.
